(19) United States
(12) Patent Application Publication
(10) Pub. No.: US 2016/0202887 A1
(43) Pub. Date: Jul. 14, 2016

(54) METHOD FOR MANAGING APPLICATION ICON AND TERMINAL

(71) Applicant: GIONEE COMMUNICATION EQUIPMENT CO.,LTD. SHENZHEN, Shenzhen (CN)

(72) Inventor: Lirong LIU, Shenzhen (CN)

(73) Assignee: GIONEE COMMUNICATION EQUIPMENT CO.,LTD. SHENZHEN, Shenzhen (CN)

(21) Appl. No.: 15/076,860

(22) Filed: Mar. 22, 2016

Related U.S. Application Data
(63) Continuation of application No. PCT/CN2014/083902, filed on Aug. 7, 2014.

(30) Foreign Application Priority Data
Mar. 18, 2014 (CN) 201410100693.1

(51) Int. Cl. G06F 3/0484; G06F 3/0488; G09G 5/14; G06F 3/0481

(52) U.S. Cl. CPC G06F 3/04845; G06F 3/04817; G06F 3/04842; G06F 3/04883; G09G 5/14; G09G 2354/00; G09G 2340/145

(57) ABSTRACT

The embodiments of the present invention provides a method for managing application icons which includes the following: displaying at least two selection boxes corresponding to different desktops respectively in a first preset region of the current display interface when a movement operation command input by a user performing a movement operation on a target application icon is obtained; determining a target selection box to which the target application icon is moved; displaying a target desktop corresponding to the target selection box in a second preset region of the current display interface; and placing the target application icon in a specified position of the target desktop according to a placing operation command input by the ser performing an operation on the target application icon. Accordingly, the embodiments of the present invention further provides a terminal.

### CROSS REFERENCE TO RELATED APPLICATIONS

This application is a continuing application of PCT Patent Application No. PCT/CN2014/083902, entitled “METHOD FOR MANAGING APPLICATION ICON AND TERMINAL”, filed on Aug. 7, 2014, which claims priority to Chinese Patent Application No. 201410100693.1, filed on Mar. 18, 2014, both of which are hereby incorporated in its entireties by reference.

### FIELD OF THE TECHNICAL

The present disclosure relates to electronic technology field, and particularly to a method for managing application icons and a terminal.

### BACKGROUND

With quick development of smart terminals, there are more and more application products. According to the statistics, averagely, there may be more than forty applications in each smart terminal, and there may be more than four desktops. A user can move application icons to any desktop to sort applications.

Currently, a method for moving an application icon mainly includes the following. The application icon is hold down and moved to a border of the current desktop, to wait for desktop switch. When switching to next desktop, the application icon is placed on the desktop. However, if the user wants to move the application icon to a desktop not adjacent to the current desktop, the user needs to wait for several times of desktop switch. Obviously, this solution is inefficiency, the operation is inconvenient, and the failure rate is high, thus user's experience is not good.

### SUMMARY

The embodiments of the present invention provides a method for managing application icons and a terminal. By means of the present invention, moving an application icon to any desktop directly can be realized, and the present invention has the features of high efficiency, easy operation, and high success rate, thereby improving user's experience.

The present invention provides a method for managing application icons which includes the following steps.

Displaying at least two selection boxes corresponding to different desktops respectively in a first preset region of the current display interface when a movement operation command input by a user performing a movement operation on a target application icon is obtained.

Determining a target selection box to which the target application icon is moved.

Displaying a target desktop corresponding to the target selection box in a second preset region of the current display interface.

Placing the target application icon in a specified position of the target desktop according to a placing operation command input by the user performing an operation on the target application icon.

Accordingly, the present invention further provides a terminal which includes the following units.

A selection box displaying unit is configured to display at least two selection boxes corresponding to different desktops respectively in a first preset region of the current display interface when a movement operation command input by a user performing a movement operation on a target application icon is obtained.

A selection box determining unit is configured to determine a target selection box to which the target application icon is moved.

A target desktop displaying unit is configured to display a target desktop corresponding to the target selection box in a second preset region of the current display interface.

An icon placing unit is configured to place the target application icon in a specified position of the target desktop according to a placing operation command input by the user performing an operation on the target application icon.

Accordingly, the present invention further provides a terminal. The terminal includes a user interface, a memory, and a processor. Wherein, the memory stores a plurality of program codes. The processor is configured to invoke the plurality of program codes stored in the memory to execute the following operations.

An operation is to display at least two selection boxes corresponding to different desktops respectively in a first preset region of the current display interface when a movement operation command input by a user performing a movement operation on a target application icon is obtained.

An operation is to determine a target selection box to which the target application icon is moved.

An operation is to display a target desktop corresponding to the target selection box in a second preset region of the current display interface.

An operation is to place the target application icon in a specified position of the target desktop according to a placing operation command input by the user performing an operation on the target application icon.

The embodiments of the present invention provides the user with selection boxes and desktops corresponding to the selection boxes, thus the function of directly moving an application icon displayed on the current display interface to the desktop corresponding to any selected selection box can be realized, and the present invention has the features of high efficiency, easy operation, and high success rate, thereby improving user's experience.

### BRIEF DESCRIPTION OF THE DRAWINGS

To better illustrate the technical solution of embodiments of the present invention, the following descriptions will briefly illustrate the accompanying drawings described in the embodiments. Obviously, the following described accompanying drawings are some embodiments of the present invention. Those skilled in the art can obtain other accompanying drawings according to the described accompanying drawings without creative work.

FIG. 1 is a flow chart of a method for managing application icons in accordance with an exemplary embodiment of the present invention.

FIG. 2 is a flow chart of another method for managing application icons in accordance with an exemplary embodiment of the present invention.

FIG. 3 is a flow chart of another method for managing application icons in accordance with an exemplary embodiment of the present invention.

FIG. 4 is a schematic view of a structure of a terminal in accordance with an exemplary embodiment of the present invention.

FIG. 5 is a schematic view of a structure of a selection box displaying unit in accordance with an exemplary embodiment of the present invention.

FIG. 6 is a schematic view showing a type of selection boxes in accordance with an exemplary embodiment of the present invention.

FIG. 7 is a schematic view showing another type of selection boxes in accordance with an exemplary embodiment of the present invention.

FIG. 8 is a schematic view showing that an application icon is moved to a selection box in accordance with an exemplary embodiment of the present invention.

FIG. 9 is a schematic view showing that an application icon is placed on a desktop in accordance with an exemplary embodiment of the present invention.

FIG. 10 is a schematic view of desktop switch in accordance with an exemplary embodiment of the present invention.

FIG. 11 is a schematic view of a structure of another terminal in accordance with an exemplary embodiment of the present invention.

### DETAILED DESCRIPTION OF ILLUSTRATED EMBODIMENTS

The technical solution of embodiments of the present invention will be described clearly and completely in combination with the accompanying drawings of the embodiments of the present invention. Obviously, the described embodiments are a part of embodiments of the present invention, and not all of the embodiments. According to the embodiments of the present invention, other embodiments obtained by those skilled in the art without creative work all fall within the protection scope of the present invention.

A method for managing application icons in accordance with an exemplary embodiment of the present invention can be applied to various smart terminals, such as smart phones, tablet computers, MP3 players, electronic readers, and so on. Wherein, the operating systems of the mobile terminals can include but not limited to Android system.

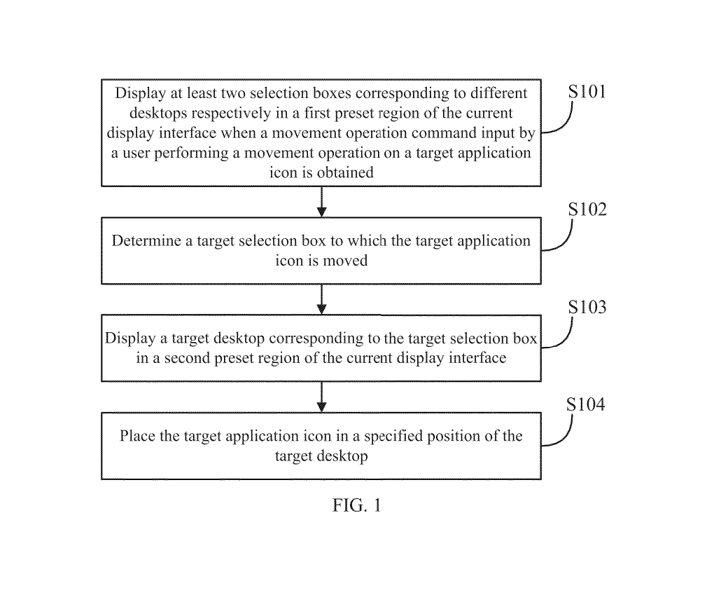

FIG. 1 is a flow chart of a method for managing application icons in accordance with an exemplary embodiment of the present invention. As shown in this figure, in this embodiment the method for managing application icons may include the following steps.

In step S101, displaying at least two selection boxes corresponding to different desktops respectively in a first preset region of the current display interface when a movement operation command input by a user performing a movement operation on a target application icon is obtained.

The display interface is an image displayed on a display screen of the terminal. A number of desktops form a main interface of an operating system of the terminal. The target application icon is a launching icon displayed on one desktop and corresponding to an application installed in the terminal. One desktop can include at least one application icon. Each selection box is a selectable function box. When an application icon is moved to one selection box, the selection box is selected. Each selection box corresponds to one desktop.

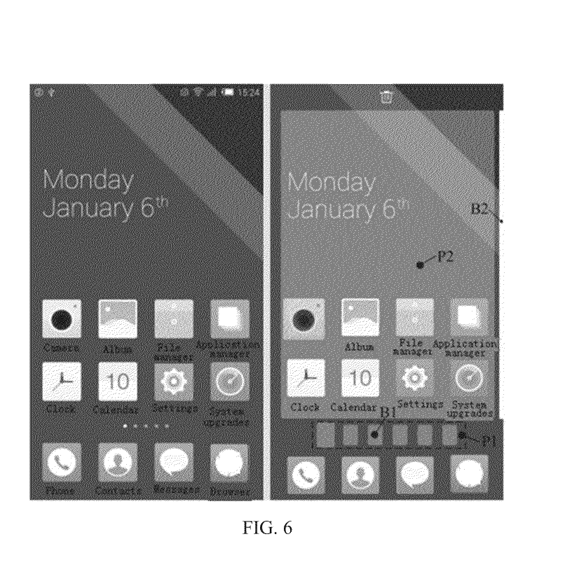

Specifically, when the user moves the target application icon, the terminal displays at least two selection boxes corresponding to different desktops respectively in the first preset region of the current display interface. Wherein, the first preset region is a preset region on the display interface. For example, referring to FIG. 6 which is a schematic view showing one type of selection boxes, the left is one desktop displayed under the condition of that there is no operation command exerted on the current display interface, and the right is another schematic view of the desktop displayed when it is detected that a movement operation command is input by the user performing a movement operation on the target application icon (the application icon of camera shown in the right). A rectangular box in the bottom of the right is one selection box (B1 shown in the right). A region accommodating a plurality of selection boxes is the first preset region (P1 shown in the right). Additionally, the movement operation command is the operation command input by the user moving the target application icon. Optionally, if the screen of the terminal is a touchscreen, the movement operation command is the operation command input by the user holding down and dragging the target application icon.

It needs to point out that FIG. 6 just shows one possible solution for displaying the selection boxes, and the embodiments of the present invention are not limited to this solution. For example, the solution of displaying the selection boxes arranged in a column on the right of the current display region, the solution of determining indicators of a split-screen indicator as the selection boxes, and other solutions all fall within the range of the present invention. Wherein, the split-screen indicator is a graphic indicator in the existing technology, and is used to indicate the current displayed desktop of all the desktops. For the graphic formed by five dots shown in the left of FIG. 6, each dot indicates one desktop.

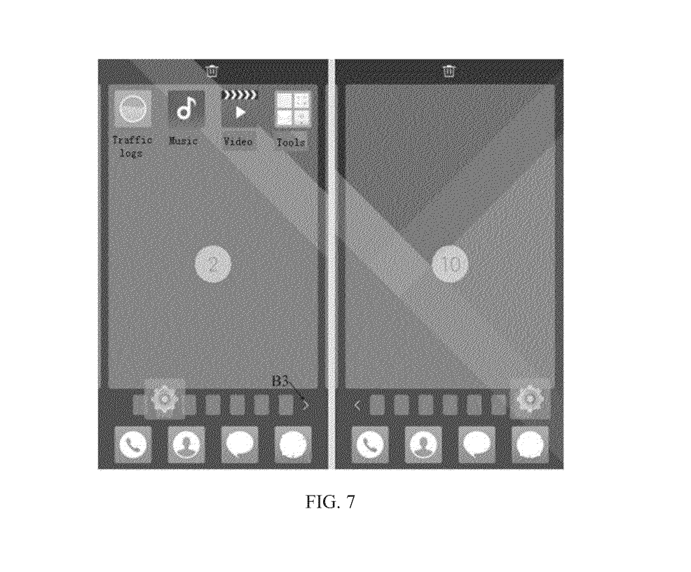

Optionally, as each selection box takes up a certain pixel space, the first preset region can only accommodate a certain number of selection boxes. Under this condition, the terminal can display a portion of selection boxes and at least one expanding box in the first preset region. The expanding box can be the symbol “>” shown in the left of FIG. 7 (that is, B3 shown in the left of FIG. 7). Furthermore, when the terminal determines that the target application icon is moved to the expanding box, the terminal displays selection boxes corresponding to the remaining desktops in the first preset region. For example, referring to FIG. 7 which is a schematic view showing another type of selection boxes, when the terminal determines that the target application icon is moved to the expanding box, as shown in the right, the other selection boxes and another expanding box are displayed in the first preset region. The another expanding box can be the symbol “<” shown in the right of FIG. 7, and the function of the another expanding box “<” is opposite to that of the expanding box “>” and will not be repeated herein.

In step S 102, determining a target selection box to which the target application icon is moved.

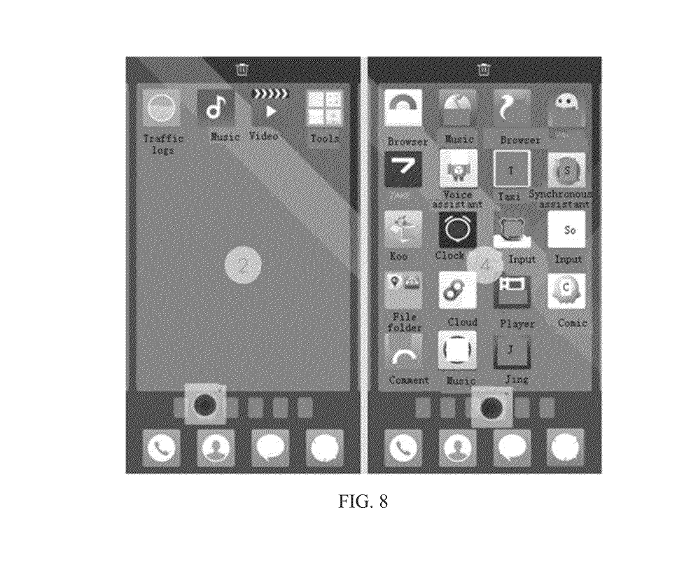

Specifically, when the target application icon is moved to one of the selection boxes by the user, the selection box is determined as the target selection box. For example, referring to FIG. 8 which is a schematic view showing that an application icon is moved to one selection box, when the target application icon (the application icon of camera shown in the figure) is moved to the second selection box shown in the left, the second selection box is determined as the target selection box by the terminal. Similarly, when the target application icon is moved to the fourth selection box shown in the right, the fourth selection box is determined as the target selection box by the terminal.

In step S103, displaying a target desktop corresponding to the target selection box in a second preset region of the current display interface.

The second preset region is another preset region of the display interface (P2 shown in FIG. 6), and is used to display a reduced desktop. When the reduced desktop is displayed, to make reduced application icons of the reduced desktop not he too small, the bottom icons can be moved downward (the four rectangular icons shown in the bottom of the right of FIG. 6). Specifically, the terminal displays the desktop corresponding to the determined target selection box in the second preset region of the current display interface, and the desktop is determined as the target desktop. For example, referring to FIG. 8, in the left, the desktop corresponding to the target selection box is the desktop which sequence number is two, thus the desktop which sequence number is two is displayed in the second preset region. In the right, the desktop corresponding to the target selection box is the desktop which sequence number is four, thus the desktop which sequence number is four is displayed in the second preset region.

In step S104, placing the target application icon in a specified position of the target desktop.

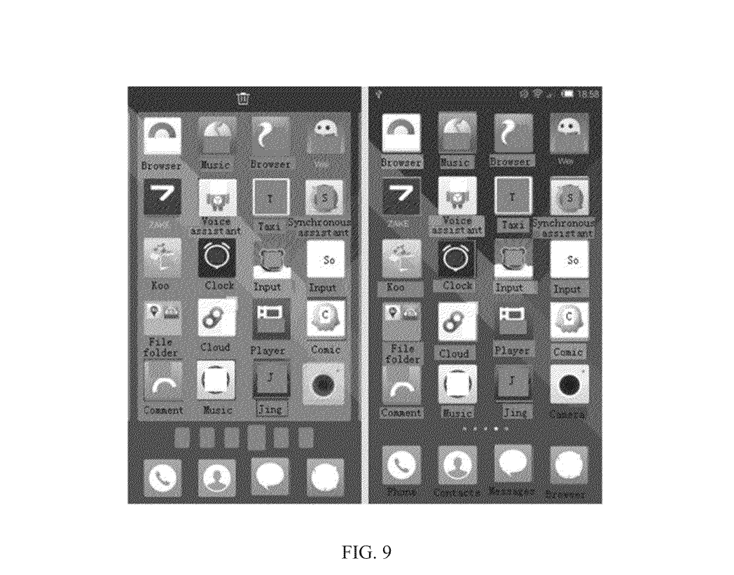

Specifically, the terminal places the target application icon in the specified position of the target desktop according to a placing operation command input by the user performing an operation on the target application icon. For example, referring to FIG. 9 which is a schematic view showing that an application icon is placed in a desktop, in the left, the target application icon (the application icon of camera in the figure) is placed in the right corner of the desktop displayed in the second preset region in response to user's operation. Correspondingly, as shown in the right, the terminal places the target application icon in a specified position of the right corner of the desktop, At this point, the whole movement operation for an application icon finishes.

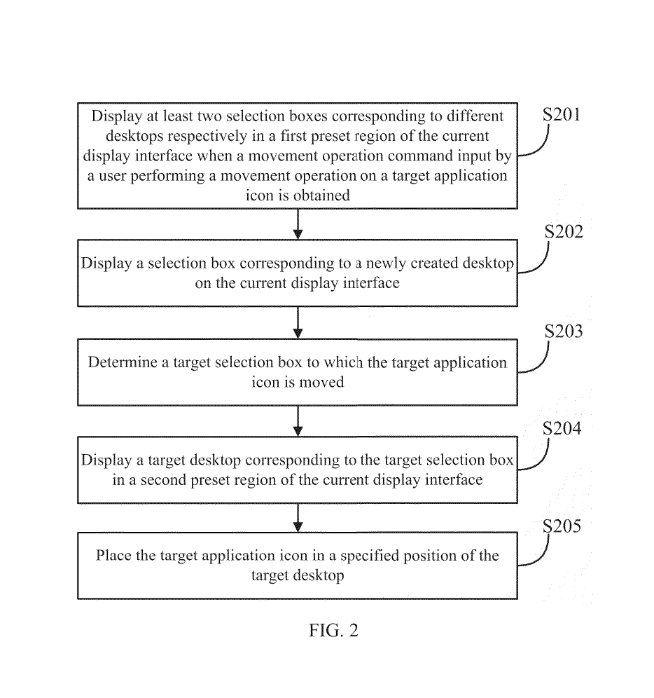

FIG. 2 is a flow chart of another method for managing application icons in accordance with an exemplary embodiment of the present invention, which may include the following steps.

In step S201, displaying at least two selection boxes corresponding to different desktops respectively in a first preset region of the current display interface when a movement operation command input by a user performing a movement operation on a target application icon is obtained.

The display interface is an image displayed on a display screen of the terminal. A number of desktops form a main interface of an operating system of the terminal. The target application icon is a launching icon displayed on one desktop and corresponding to an application installed in the terminal. One desktop can include at least one application icon. Each selection box is a selectable function box, When an application icon is moved to one selection box, the selection box is selected. Each selection box corresponds to one desktop.

Specifically, when the user moves the target application icon, the terminal displays at least two selection boxes and at least one expanding box in the first preset region of the current display interface. The expanding box can be the symbol “>” shown in the left of FIG. 7. Wherein, the first preset region is a preset region on the display interface. For example, referring to FIG. 7 which is a schematic view showing one type of selection boxes, when a movement operation command is input by the user performing a movement operation on the target application icon (the application icon of setting), rectangular boxes in the bottom of the left or the right are the selection boxes, and the region accommodating the plurality of selection boxes is the first preset region. Additionally, the movement operation command is the operation command input by the user moving the target application icon. Optionally, if the screen of the terminal is a touchscreen, the movement operation command is the operation command input by the user holding down and dragging the target application icon. Furthermore, when the terminal determines that the target application icon is moved to the expanding box, the terminal displays selection boxes corresponding to the remaining desktops in the first preset region. For example, referring to FIG. 7 which is a schematic view showing another type of selection boxes, when the terminal determines that the target application icon is moved to the expanding box, as shown in the right, the other selection boxes and another expanding box are displayed in the first preset region. The another expanding box can be the symbol “<” shown in the right of FIG. 7, and the function of the another expanding box “<” is opposite to that of the expanding box “>” and will not be repeated herein.

It needs to point out that FIG. 7 just shows one possible solution for displaying the selection boxes, and the embodiments of the present invention are not limited to this solution. For example, the solution of displaying the selection boxes arranged in a column on the right of the current display region, the solution of determining indicators of a split-screen indicator as the selection boxes, and other solutions all fall within the range of the present invention. Wherein, the split-screen indicator is a graphic pointer in the existing technology, and is used to indicate the current displayed desktop of all the desktops.

Particularly, if the first preset region can accommodate all the selection boxes, the expanding box is not needed. For example, the first preset region shown in FIG. 6, FIG. 8, and FIG. 9 can accommodate all the selection boxes.

In step S202, displaying a selection box corresponding to a newly created desktop on the current display interface.

Specifically, the terminal. creates a blank desktop and displays a selection box corresponding to the newly created desktop on the current display interface. For example, the terminal display a strip shaped selection box in the right border of the display interface (B2 shown in FIG. 6). When the target application icon is moved to the border of the display interface, the selection box is selected.

In step S203, determining a target selection box to which the target application icon is moved.

Specifically, when the target application icon is moved to one of the selection boxes by the user, the selection box is determined as the target selection box by the terminal. The selection box can be the selection box corresponding to the non-newly created desktop in step S201, or can be the selection box corresponding to the newly created desktop in step S202. Specifically, take the selection box corresponding to the non-newly created desktop as an example, referring to FIG. 8, when the target application icon (the application icon of camera) is moved to the second selection box in the left, the second selection box is determined as the target selection box by the terminal. Similarly, when the target application icon is moved to the fourth selection box, the fourth selection box is determined as the target selection box by the terminal.

In step S204, displaying a target desktop corresponding to the target selection box in a second preset region of the current display interface.

The second preset region is another preset region of the display interface, and is used to display a reduced desktop. When the reduced desktop is displayed, to make reduced application icons of the reduced desktop not be too small, the bottom icons can be moved downward (the four rectangular icons shown in the bottom of the right of FIG. 6). Specifically, the terminal displays the desktop corresponding to the determined target selection box in the second preset region of the current display interface, and the desktop is determined as the target desktop. For example, referring to FIG. 8, in the left, the desktop corresponding to the target selection box is the desktop which sequence number is two, thus the desktop which sequence number is two is displayed in the second preset region. In the right, the desktop corresponding to the target selection box is the desktop which sequence number is four, thus the desktop which sequence number is four is displayed in the second preset region. Furthermore, if the target selection box is the selection box corresponding to the newly created desktop, the newly created and blank desktop is directly displayed in the second preset region.

In step S205, placing the target application icon in a specified position of the target desktop.

Specifically, the terminal places the target application icon in the specified position of the target desktop according to a placing operation command input by the user performing an operation on the target application icon. For example, referring to FIG. 9 which is a schematic view showing that an application icon is placed in a desktop, in the left, the target application icon (the application icon of camera in the figure) is placed in the right corner of the desktop displayed in the second preset region in response to user's operation. Correspondingly, as shown in the right, the terminal places the target application icon in a specified position of the right corner of the desktop. Furthermore, when the target selection box is the selection box corresponding to the newly created desktop, the implementation method for placing the target application icon is similar to the above embodiment and will not be repeated herein. At this point, the whole movement operation for an application icon finishes.

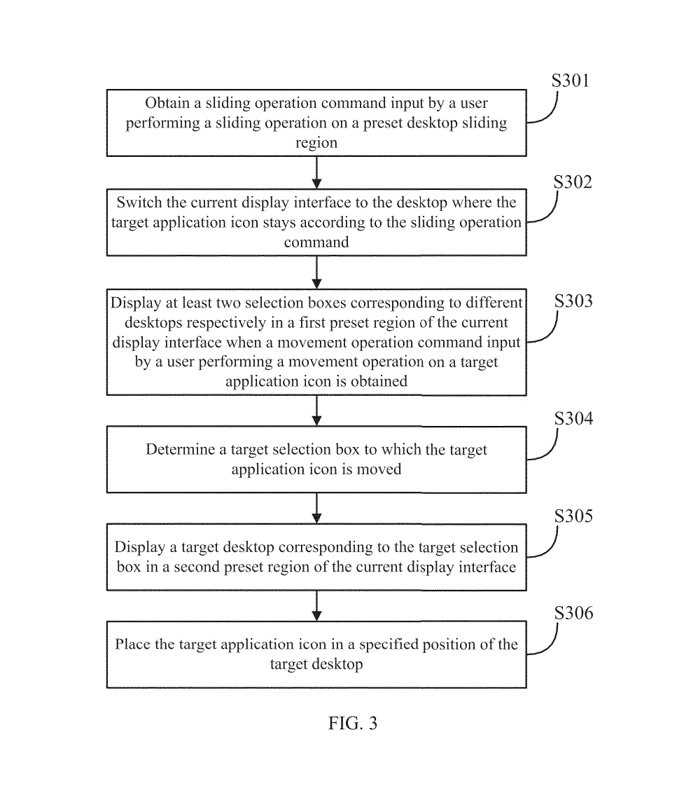

Optionally, FIG. 3 is a flow chart of another method for managing application icons in accordance with an exemplary embodiment of the present invention, which may include the following steps.

In step S301, obtaining a sliding operation command input by a user performing a sliding operation on a preset desktop sliding region.

The preset desktop sliding region may be a function region in which the sliding operation performed by the user can be recognized. For example, the preset desktop sliding region may be the region where a split-screen indicator stays. Wherein, the split-screen indicator is used to indicate the displayed desktop of all the desktops on the current display interface.

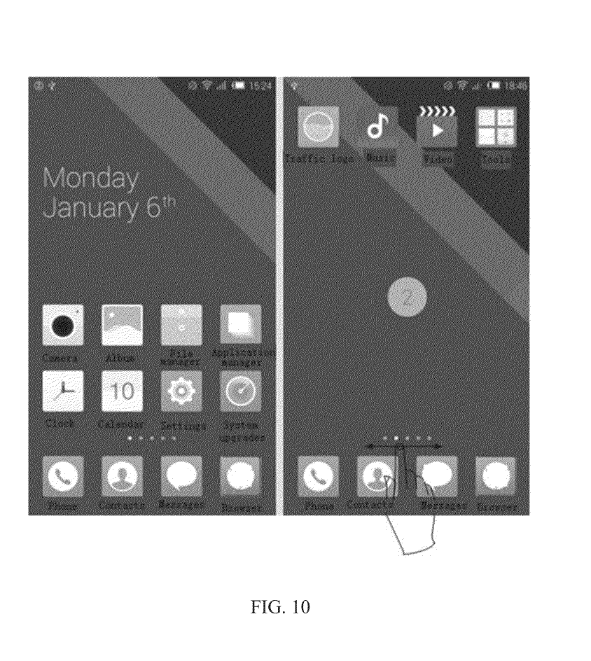

Specifically, the terminal obtains the sliding operation command input by the user performing a sliding operation on the preset desktop sliding region. For example, if the desktop sliding region is the region where the split-screen indicator stays and the screen of the terminal is a touchscreen, referring to FIG. 10 which is a schematic view showing desktop switch, when the user slides the finger around on the split-screen indicator as shown in the right, the terminal obtains the current position of the finger.

In step S302, switching the current display interface to the desktop where the target application icon stays according to the sliding operation command.

The detailed implementation method for desktop switch may include the following. Referring to FIG. 10, the terminal switches desktops back and forth according to the operation command input by the user sliding the finger around. That is, the desktop displayed on the current interface is the desktop corresponding to the current position of the finger. By means of this method, desktop switch is quick, and it does not need to switch from page to page, thereby increasing efficiency and improving user's experience.

Specifically, by means of the above method for desktop switch, the terminal switches the current interface to the desktop where the target application icon stays according to the sliding operation command, thus the user can perform a movement operation on the target application icon.

Wherein, subsequent steps S303-S306 are respectively the same as steps S101-S104 and will not be repeated herein.

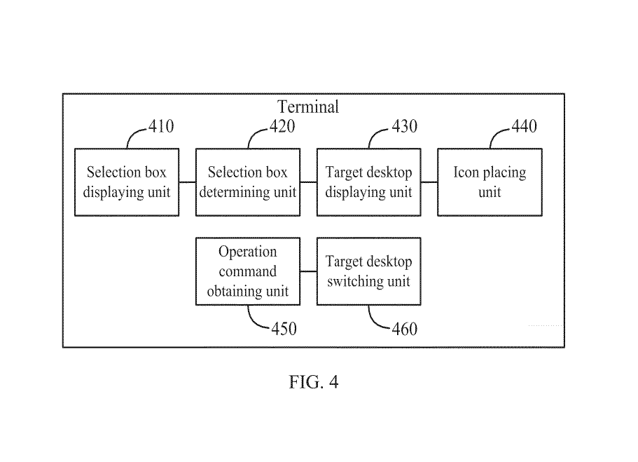

FIG. 4 is a schematic view of a structure of a terminal in accordance with an exemplary embodiment of the present invention. As shown in this figure, the terminal in accordance with an exemplary embodiment of the present invention at least include a selection box displaying unit 410, a selection box determining unit 420, a target desktop displaying unit 430, and an icon placing unit 440.

The selection box displaying unit 410 is configured to display at least two selection boxes corresponding to different desktops respectively in a first preset region of the current display interface when a movement operation command input by a user performing a movement operation on a target application icon is obtained.

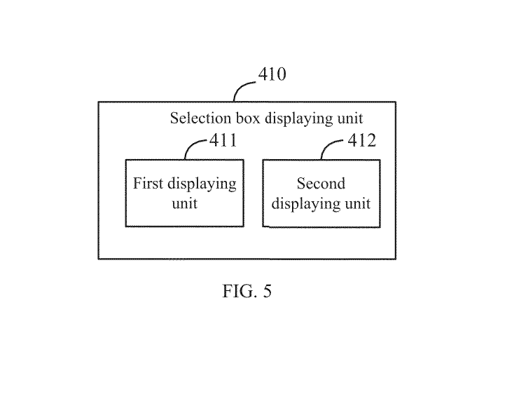

Specifically, as shown in FIG. 5, the selection box displaying unit 410 can further include a first displaying unit 411 and a second displaying unit 412.

The first displaying unit 411 is configured to display at least two selection boxes each corresponding to one desktop and at least one expanding box in a first preset region of the current display interface.

The display interface is an image displayed on a display screen of the terminal. A number of desktops form a main interface of an operating system of the terminal. The target application icon is a launching icon displayed on one desktop and corresponding to an application installed in the terminal. One desktop can include at least one application icon. Each selection box is a selectable function box. When one application icon is moved to one selection box, the selection box is selected. Each selection box corresponds to one desktop.

Specifically, when a movement operation command input by the user performing a movement operation on the target application icon is obtained, the first displaying unit 411 displays at least two selection boxes and at least one expanding box in the first preset region of the current display interface. The expanding box can be the symbol “>” shown in the left of FIG. 7. Wherein, the first preset region is a preset region on the display interface. For example, referring to FIG. 7 which is a schematic view showing one type of selection boxes, when a movement operation command is input by the user performing a movement operation on the target application icon (the application icon of setting), rectangular boxes in the bottom of the left or the right are the selection boxes, and the region accommodating the plurality of selection boxes is the first preset region. Additionally, the movement operation command is the operation command input by the user moving the target application icon. Optionally, if the screen of the terminal is a touch.screen, the movement operation command is the operation command input by the user holding down and dragging the target application icon.

It needs to point out that FIG. 7 just shows one possible solution for displaying the selection boxes, and the embodiments of the present invention are not limited to this solution. For example, the solution of displaying the selection boxes and the expanding box arranged in a column on the right of the current display region, the solution of determining indicators of a split-screen indicator as the selection boxes and the expanding box, and other solutions all fall within the range of the present invention. Wherein, the split-screen indicator is a graphic pointer in the existing technology, and is used to indicate the current displayed desktop of all the desktops.

Particularly, if the first preset region can accommodate all the selection boxes, the expanding box is not needed. For example, the first preset region shown in FIG. 6, FIG. 8, and FIG. 9 can accommodate all the selection boxes.

The second displaying unit 412 is configured to display selection boxes each corresponding to one of the remaining desktops in the first preset region of the current display interface when it is determined that the target application icon is moved to the expanding box.

Specifically, when the second displaying unit 412 determines that the target application icon is moved to the expanding box, the second displaying unit 412 displays selection boxes each corresponding to one of the remaining desktops in the first preset region of the current display interface. For example, referring to FIG. 7 which is a schematic view of another type of selection boxes, when the second displaying unit 412 determines that the target application icon is moved to the expanding box, as shown in the right, the other selection boxes and another expanding box are displayed in the first preset region. The another expanding box can be the symbol “<” shown in the right, and the function of the another expanding box “<” is opposite to that of the expanding box “>” and will not be repeated herein.

The selection box determining unit 420 is configured to determine a target selection box to which the target application icon is moved.

Specifically, when the target application icon is moved to one of the selection boxes by the user, the selection box is determined as the target selection box by the selection box determining unit 420. The selection box can be the selection box corresponding to a non-newly created desktop, or can be the selection box corresponding to a newly created desktop. Specifically, take the selection box corresponding to the non-newly created desktop as an example, referring to FIG. 8, when the target application icon (the application icon of camera) is moved to the second selection box in the left, the second selection box is determined as the target selection box by the selection box determining unit 420. Similarly, when the target application icon is moved to the fourth selection box, the fourth selection box is determined as the target selection box by the selection box determining unit 420.

The target desktop displaying unit 430 is configured to display a target desktop corresponding to the target selection box in a second preset region of the current display interface.

The second preset region is another preset region of the display interface, and is used to display a reduced desktop. When the reduced desktop is displayed, to make reduced application icons of the reduced desktop not be too small, the bottom icons can be moved downward (the four rectangular icons shown in the bottom of the right of FIG. 6). Specifically, the target desktop displaying unit 430 displays the desktop corresponding to the determined target selection box in the second preset region of the current display interface, and the desktop is determined as the target desktop. For example, referring to FIG. 8, in the left, the desktop corresponding to the target selection box is the desktop which sequence number is two, thus the desktop which sequence number is two is displayed in the second preset region. In the right, the desktop corresponding to the target selection box is the desktop which sequence number is four, thus the desktop which sequence number is four is displayed in the second preset region. Furthermore, if the target selection box is the selection box corresponding to the newly created desktop, the newly created and blank desktop is directly displayed in the second preset region.

The icon placing unit 440 is configured to place the target application icon in a specified position of the target desktop according to a placing operation command input by the user performing an operation on the target application icon.

Specifically, the icon placing unit 440 is configured to place the target application icon in a specified position of the target desktop according to a placing operation command input by the user performing an operation on the target application icon. For example, referring to FIG. 9 which is a schematic view showing that an application icon is placed in a desktop, in the left, the target application icon (the application icon of camera in the figure) is placed in the right corner of the desktop displayed in the second preset region in response to user's operation. Correspondingly, as shown in the right, the icon placing unit 440 places the target application icon in a specified position of the right corner of the desktop. Furthermore, when the target selection box is the selection box corresponding to the newly created desktop, the implementation method for placing the target application icon is similar to the above embodiment and will not be repeated herein. At this point, the whole movement operation for an application icon finishes.

Optionally, referring to FIG. 4 which shows a terminal, the terminal can further include an operation command obtaining unit 450 and a target desktop switching unit 460.

The operation command obtaining unit 450 is configured to obtain a sliding operation command input by a user performing a sliding operation on a preset desktop sliding region.

The preset desktop sliding region may be a function region in which the sliding operation performed by the user can be recognized. For example, the preset desktop sliding region may be the region where a split-screen indicator stays. Wherein, the split-screen indicator is used to indicate the displayed desktop of all the desktops on the current display interface.

Specifically, the operation command obtaining unit 450 obtains the sliding operation command input by the user performing a sliding operation on the preset desktop sliding region. For example, if the desktop sliding region is the region where the split-screen indicator is and the screen of the terminal is a touchscreen, referring to FIG. 10 which is a schematic view showing desktop switch, when the user slides the finger around on the split-screen display shown in the right, the operation command obtaining unit 450 obtains the current position of the finger.

The target desktop switching unit 460 is configured to switch the current display interface to the desktop where the target application icon stays according to the sliding operation command.

The detailed implementation method for desktop switch may include the following. Referring to FIG. 10, the terminal switches desktops back and forth according to the operation command input by the user sliding the finger around. That is, the desktop displayed on the current interface is the desktop corresponding to the current position of the finger. By means of this method, desktop switch is quick, and it does not need to switch from page to page, thereby increasing efficiency and improving user's experience.

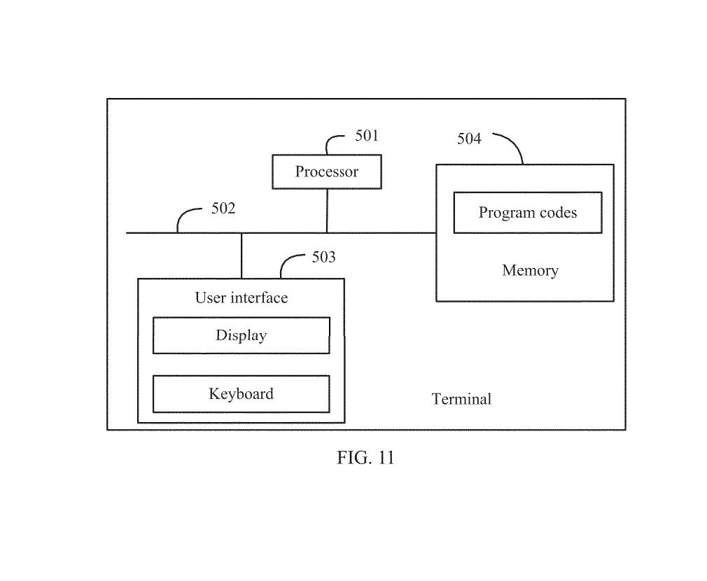

FIG. 11 is a schematic view of a structure of a terminal in accordance with another exemplary embodiment of the present invention. As shown in FIG. 11, the terminal includes at least one processor 501 (e.g., CPU), at least one user interface 503, a memory 504, and at least one communication bus 502. Wherein, the communication bus 502 is configured to realize communication among these assemblies. Wherein, the user interface 503 can include a display and a keyboard. Optionally, the user interface 503 can further include standard wired interfaces and wireless interfaces. The memory 504 can be a high-speed RAM, or can be a non-volatile memory, such as at least one disc memory. Optionally, the memory 504 can be at least one storage device which is away from the processor 501. The memory 504 stores a plurality of program codes. The processor 501 invokes the program codes stored in the memory 504 to execute the following operation.

An operation is to display at least two selection boxes corresponding to different desktops respectively in a first preset region of the current display interface when a movement operation command input by a user performing a movement operation on a target application icon is obtained.

An operation is to determine a target selection box to which the target application icon is moved.

An operation is to display a target desktop corresponding to the target selection box in a second preset region of the current display interface.

An operation is to place the target application icon in a specified position of the target desktop according to a placing operation command input by the user performing an operation on the target application icon.

Optionally, the processor 501 being configured to execute the program codes to display at least two selection boxes corresponding to different desktops respectively in a first preset region of the current display interface when a movement operation command input by a user performing a movement operation on a target application icon is obtained comprises the following operations.

An operation is to display at least two selection boxes corresponding to a portion of the desktops and at least one expanding box in the first preset region of the current display interface.

An operation is to display selection boxes corresponding to the remaining desktops in the first preset region of the current display interface when it is determined that the target application icon is moved to the expanding box.

Optionally, before determining the target selection box to which the target application icon is moved, the processor 501 is further configured to execute the following operations.

An operation is to display a selection box corresponding to a newly created desktop on the current display interface.

Optionally, the processor 501 is further configured to execute the following operations.

An operation is to obtain a sliding operation command input by a user performing a sliding operation on a preset desktop sliding region.

An operation is to switch the current display interface to the target desktop according to the sliding operation command.

Furthermore, the preset desktop sliding region includes a display region where a split-screen indicator stays. The split-screen indicator is used to indicate the displayed desktop of all the desktops on the current display interface.

Specifically, the terminal illustrated in this embodiment can be used to implement a portion of or all of procedures in embodiments of the method for managing application icons illustrated in combination with FIG. 1, FIG. 2, or FIG. 3.

The embodiments of the present invention provides the user with selection boxes and desktops corresponding to the selection boxes, thus the function of directly moving an application icon displayed on the current display interface to the desktop corresponding to any selected selection box can be realized, and the present invention has the features of high efficiency, easy operation, and high success rate, thereby improving user's experience.

One of ordinary skill in the art can understand that all or part of process can be accomplished by using a computer program to instruct related hardware. All the program can be stored in a computer-readable storage medium. When the program is executed, the process of the embodiments of the above-mentioned methods can be included. Wherein, the storage medium can be a magnetic disk, an optical disk, a ROM (Read-Only Memory, ROM), a RAM (Random Access Memory, RAM), or the like.

According to actual need, the order of the steps of the methods in the embodiments of the present invention can be adjusted, some steps can be merged into one step, and some step can be deleted.

According to actual need, some units of the device in the embodiments of the present invention can be merged into one unit, some unit can be divided into several units, and some unit can be deleted.

The units in all embodiments of the present invention can be realized by a universal integrated circuit, such as a CPU (Central Processing unit, CPU) for example, or by an ASIC (Application Specific Integrated Circuit, ASIC).

The embodiments described above are merely preferred ones of the present disclosure but are not limitations to the protection scope of the present disclosure, thus equivalent variations made according to the appended claims of the present invention still fall within the scope of the present invention.

What is claimed is:

1. A method for managing application icons, comprising:
displaying at least two selection boxes corresponding to different desktops respectively in a first preset region of the current display interface when a movement operation command input by a user performing a movement operation on a target application icon is obtained;
determining a target selection box to which the target application icon is moved;
displaying a target desktop corresponding to the target selection box in a second preset region of the current display interface; and
placing the target application icon in a specified position of the target desktop according to a placing operation command input by the user performing an operation on the target application icon.

2. The method of claim 1, wherein displaying at least two selection boxes corresponding to different desktops respectively in a first preset region of the current display interface comprises displaying at least two selection boxes corresponding to a portion of the desktops and at least one expanding box in the first preset region of the current display interface, and displaying selection boxes corresponding to the remaining desktops in the first preset region of the current display interface when it is determined that the target application icon is moved to the expanding box.

3. The method of claim 1, wherein before determining the target selection box to which the target application icon is moved, the method further comprises displaying a selection box corresponding to a newly created desktop on the current display interface.

4. The method of claim 1, wherein the method further comprises obtaining a sliding operation command input by a user performing a sliding operation on a preset desktop sliding region, and switching the current display interface to the target desktop according to the sliding operation command.

5. The method of claim 4, wherein the preset desktop sliding region comprises a display region where a split-screen indicator stays, and the split-screen indicator is used to indicate the displayed desktop of all the desktops on the current display interface.

6. A terminal comprising:
a selection box displaying unit configured to display at least two selection boxes corresponding to different desktops respectively in a first preset region of the current display interface when a movement operation command input by a user performing a movement operation on a target application icon is obtained;
a selection box determining unit configured to determine a target selection box to which the target application icon is moved;
a target desktop displaying unit configured to display a target desktop corresponding to the target selection box in a second preset region of the current display interface; and
an icon placing unit configured to place the target application icon in a specified position of the target desktop according to a placing operation command input by the user performing an operation on the target application icon.

7. The terminal of claim 6, wherein the selection box displaying unit comprises a first displaying unit configured to display at least two selection boxes corresponding to a portion of the desktops and at least one expanding box in the first preset region of the current display interface, and a second displaying unit configured to display selection boxes corresponding to the remaining desktops in the first preset region of the current display interface when it is determined that the target application icon is moved to the expanding box.

8. The terminal of claim 6, wherein the selection box displaying unit is further configured to display a selection box corresponding to a newly created desktop on the current display interface.

9. The terminal of claim 6, wherein the terminal further comprises an operation command obtaining unit configured to obtain a sliding operation command input by a user performing a sliding operation on a preset desktop sliding region, and a target desktop switching unit configured to switch the current display interface to the target desktop according to the sliding operation command.

10. The terminal of claim 9, wherein the preset desktop sliding region comprises a display region where a split-screen indicator stays, and the split-screen indicator is used to indicate the displayed desktop of all the desktops on the current display interface.

11. A terminal comprising:
a user interface;
a memory storing a plurality of program codes; and
a processor configured to invoke the plurality of program codes stored in the memory to:
display at least two selection boxes corresponding to different desktops respectively in a first preset region of the current display interface when a movement operation command input by a user performing a movement operation on a target application icon is obtained;
determine a target selection box to which the target application icon is moved;
display a target desktop corresponding to the target selection box in a second preset region of the current display interface;
place the target application icon in a specified position of the target desktop according to a placing operation command input by the user performing an operation on the target application icon.
